(19) United States
(12) Patent Application Publication
(10) Pub. No.: US 2009/0254407 A1
(43) Pub. Date: Oct. 8, 2009

(54) SYSTEMS AND METHODS FOR EVENT COORDINATION AND ASSET CONTROL

(75) Inventors: Marc MacKeen Fagan, Essex, MA (US); Richard Dean Fiery, JR., S. Hamilton, MA (US); Michael Phillip Schenck, Malden, MA (US); Jayanta Mukhopadhyay, Woburn, MA (US)

Correspondence Address: LANDO & ANASTASI, LLP, ONE MAIN STREET, SUITE 1100, CAMBRIDGE, MA, 02142, US

(73) Assignee: ENVISTA CORPORATION, Beverly, MA (US)

(21) Appl. No.: 12/417,278

(22) Filed: Apr. 2, 2009

Related U.S. Application Data
(60) Provisional application No. 61/072,763, filed on Apr. 2, 2008.
(60) Provisional application No. 61/155,623, filed on Feb. 26, 2009.

(51) Int. Cl. G06Q 10/00

(52) U.S. Cl. 705/9; 705/8

(57) ABSTRACT

Event coordination systems and methods are disclosed. The event coordination system can include an input module that can receive information identifying multiple projects. The event coordination system can also include a controller that can generate a geocoded representation of the information identifying the projects. A project status attribute of at least one of the projects can be identified, and the geocoded representation can include an indication of the project status attribute.

### CROSS REFERENCE TO RELATED APPLICATIONS

This application claims priority under 35 U.S.C. 119(e) to U.S. Provisional Application Ser. No. 61/072,763 entitled “Method and Apparatus for Sharing and Coordinating Planning Information,” filed Apr. 2, 2008, and to U.S. Provisional Application Ser. No. 61/155,623 also entitled “Method and Apparatus for Sharing and Coordinating Planning Information,” filed Feb. 26, 2009, both of which are incorporated herein by reference in their entirety.

### BACKGROUND OF THE INVENTION

1. Field of Invention

At least one embodiment of the present invention relates generally to infrastructure creation or maintenance, and more specifically, to coordination of various types of infrastructure activity.

2. Discussion of Related Art

Physical infrastructure, utility networks, grids, and other forms of physical air, land, or sea development benefit individuals, businesses, and communities at local, regional, and national levels. Infrastructure, from buildings to roads to pipelines and cables, provide access, energy, shelter, water, gas, oil, electricity, waste, transportation routes, and areas of recreation, among other staples of civilization. As populations and economic activity grow and shift in location, new infrastructure is created, and existing infrastructure is maintained or upgraded.

The condition of various types of infrastructure generally degrades with time or use. Further, new or different infrastructure can overlap, replace, or repair all or portions of existing infrastructure. The creation of new infrastructure and existing infrastructure maintenance can be expensive and complicated, and such work may take a long time to complete. This is burdensome for public, private, and hybrid entities responsible for infrastructure creation or maintenance, as well as users of the resulting infrastructure.

### SUMMARY OF THE INVENTION

The aspects and embodiments of the present invention are directed to systems and methods for event coordination. Information identifying multiple projects can be received, coordinated, and provided to entities in a geocoded representation that can indicate a plurality of project status attributes.

At least one aspect is directed to an event coordination system. The event coordination system can include an input module configured to receive information identifying multiple projects. The event coordination system can also include a controller that can be configured to generate a geocoded representation of the information identifying the projects. The controller can be further configured to identify a project status attribute of at least one of the projects based at least in part on the information identifying the projects. The geocoded representation can include an indication of the project status attribute.

At least one other aspect is directed to a computer implemented method of event coordination. The computer implemented method can receive information identifying a first project and information identifying a second project, and can generate a geocoded representation of the information. The computer implemented method can also identify a project status attribute of at least one of the first project and the second project. The project status attribute can be based at least in part on the information identifying the first project and the information identifying the second project. The computer implemented method can also indicate the project status attribute in the geocoded representation.

At least one other aspect is directed to a computer readable medium having stored thereon sequences of instructions, the sequences of instructions including instructions that, when executed by a processor, cause the processor to receive information associated with a first project at a first geographic location and information associated with a second project at a second geographic location. The instructions can cause the processor to juxtapose, in a geocoded representation of the information associated with the first project and the information associated with the second project, the first geographic location and the second geographic location. The instructions can further cause the processor to identify a project status attribute of at least one of the first project and the second project based at least in part on the information associated with any of the first project, the second project, the first geographic location, and the second geographic location. The instructions can also cause the processor to indicate the project status attribute in the geocoded representation.

At least one other aspect is directed to an asset management system having a data store that includes information from a periodic condition assessment of a tangible infrastructure asset. A controller can be configured with a model of the tangible infrastructure asset; and a user interface, in combination with the controller, can associate the infrastructure asset with the model. The controller can use the model to create an activity scenario of the tangible infrastructure asset based on the information in the data store and a future physical condition level of the tangible infrastructure asset.

At least one other aspect is directed to an asset management system having a data store that includes data from a periodic condition assessment of tangible transportation infrastructure assets. The asset management system can also include a model of the tangible transportation infrastructure assets and a server configured to execute the model and to associate one of the tangible transportation infrastructure assets with the model. The server can provide asset management system services to user interface applications, using the data for tangible transportation infrastructure assets in the data store and the model. The server can use the model to create an activity scenario of the tangible transportation infrastructure asset based on the data in the data store and a future physical condition level of the tangible transportation infrastructure asset. The server can also provide the activity scenario to user interface applications.

In various embodiments, the controller may provide the geocoded representation to a display, and the geocoded representation may identify the first project and the second project in at least one of a tabular format and a geographic format. The controller may also provide the geocoded representation with time attributes associated with an implementation schedule of at least one of the first project and the second project. The information identifying the projects may include at least one of type, location, time, and status information, and the controller may provide the geocoded representation to at least one of a plurality of entities.

The controller can track changes to the project status attribute during a time period, and include the tracked changes in the geocoded representation. The controller can adjust the geocoded representation based at least in part on changes to the project status attribute. The project status attribute may include at least one of a project interference attribute, a project conflict attribute, a project milestone attribute, a project change attribute, a project progress attribute, a project schedule, and project conflict resolution attribute.

In some embodiments, the input module may receive revised information identifying at least one of the first and second projects, and the controller may modify the project status attribute based on the revised information. The input module may also receive revised information identifying at least one of the first and second projects, and the controller may modify the geocoded representation based on the revised information. The geocoded representation may include a schedule to implement at least one of the first project and the second project, and the geocoded representation may include information indicating a moratorium time period associated with a geographic location of at least one of the first and second projects. The geocoded representation may indicate that implementation of one of a plurality of projects is prohibited or restricted. The geocoded representation may also indicate authorization to implement one of the first and second projects. In various embodiments, the controller may juxtapose, in a display of the geocoded representation, a geographic location associated with the first project and a geographic location associated with the second project. The geographic location of the projects can overlap it total or in part. In some embodiments, the geographic location of the projects can be adjacent or separated by a third geographic location.

These aspects and embodiments are achieved by the methods and systems according to independent claim 1 and any other independent claims. Further details may be found in the remaining dependent claims.

Other aspects, embodiments, and advantages of these exemplary aspects and embodiments will become apparent from the following detailed description, taken in conjunction with the accompanying drawings, illustrating the principles of the invention by way of example only. The foregoing information and the following detailed description include illustrative examples of various aspects and embodiments, and are intended to provide an overview or framework for understanding the nature and character of the claimed aspects and embodiments. The drawings, together with the remainder of the specification, serve to explain principles and operations of the described and claimed aspects and embodiments.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a block diagram depicting an event coordination system in accordance with an embodiment of the invention;

FIG. 2 illustrates a table depicting event coordination in accordance with an embodiment of the invention;

FIG. 2A illustrates a block diagram depicting project information for event coordination in accordance with an embodiment of the invention;

FIG. 3 illustrates a geocoded representation depicting event coordination in accordance with an embodiment of the invention;

FIG. 4 illustrates a geocoded representation depicting project status attributes for event coordination in accordance with an embodiment of the invention;

FIG. 5 illustrates a geocoded representation representing a conflict of scheduled events in accordance with an embodiment of the invention;

FIG. 6 illustrates a geocoded representation depicting conflict notification in accordance with an embodiment of the invention;

FIG. 7 illustrates a geocoded representation depicting conflict resolution and planning in accordance with an embodiment of the invention;

FIG. 8 illustrates a project timeline in accordance with an embodiment of the invention;

FIG. 9 illustrates a geocoded representation depicting an opportunity in accordance with an embodiment of the invention;

FIG. 10 illustrates a geocoded representation depicting a moratorium in accordance with an embodiment of the invention; and

FIG. 11 is a flow chart depicting a method of event coordination in accordance with an embodiment of the invention.

### DETAILED DESCRIPTION

The systems and methods described herein are not limited in their application to the details of construction and the arrangement of components set forth in the description or illustrated in the drawings. The invention is capable of other embodiments and of being practiced or of being carried out in various ways. Also, the phraseology and terminology used herein is for the purpose of description and should not be regarded as limiting. The use of “including” “comprising” “having” “containing” “involving” and variations thereof herein, is meant to encompass the items listed thereafter and equivalents thereof as well as additional items.

Various aspects and embodiments are directed to event coordination and asset management systems and methods. Project managers (e.g., employees) of different entities, such as companies, provide information associated with a plurality of projects. These projects can include infrastructure projects such as work on road, sewer, or utility networks, for example, and these projects can occur in different locations or at different times throughout a geographic area, such as a city. Further, these projects can overlap at least partially in space or time, which may give rise to conflicts or opportunities for cooperation. Uncoordinated project information received from a plurality of independent sources can be evaluated and coordinated into a geocoded representation. The geocoded representation may be provided to a plurality of entities to, for example, facilitate implementation of independent projects.

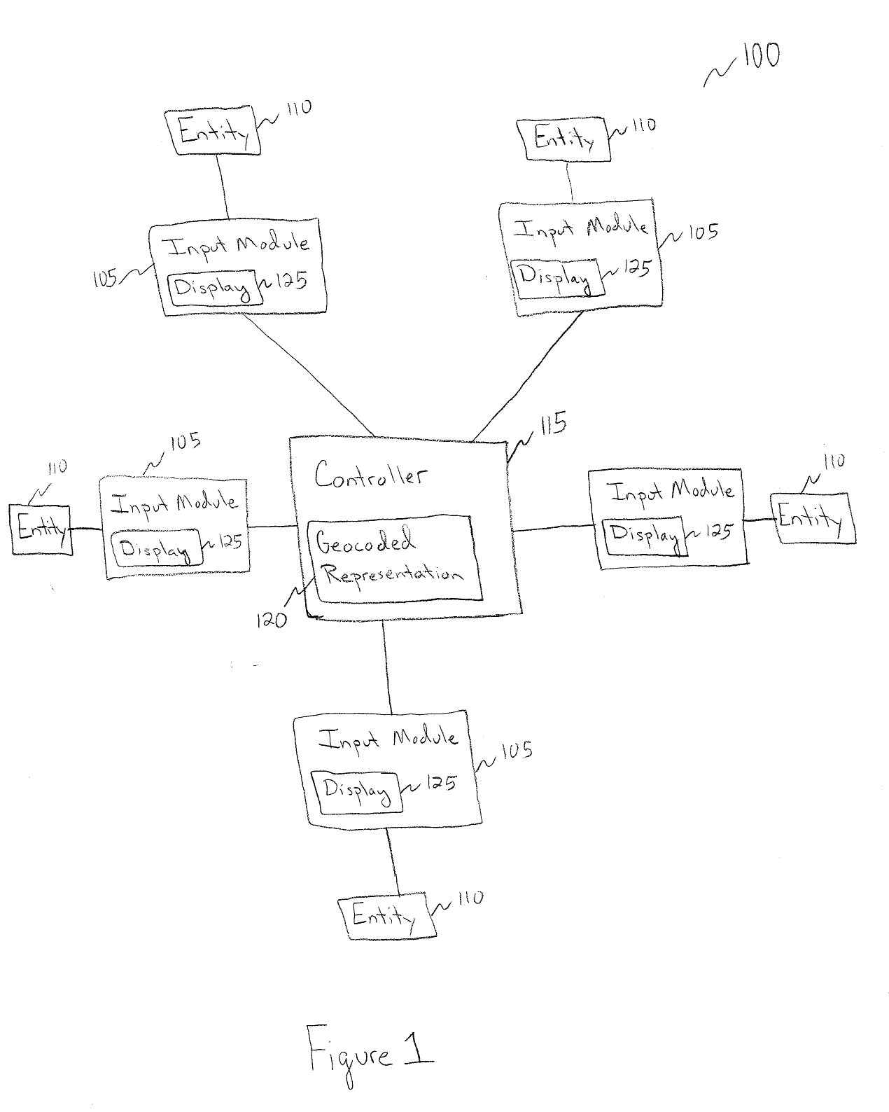

FIG. 1 illustrates a block diagram depicting event coordination system 100. In one embodiment, system 100 includes at least one input module 105 configured to receive information related to at least one project. In one embodiment, input module 105 includes a controller or processor configured to receive project information. In another embodiment, input module 105 may include a user interface such as a keyboard, mouse, or touchpad, and may be part of a computer configured to receive data. In one embodiment, input module 105 receives information in a geographic information system (GIS) or GIS compatible format. Input module 105 may also receive information in a comma separated format, (e.g. a spreadsheet) or a keyhole or other extensible markup language format. Input module 105 may receive information directly from a user, for example typing into a keyboard, or remotely via an area network or the Internet.

System 100 may also include or communicate with at least one entity 110. In one embodiment input module 105 receives project information from entity 110. For example, entity 110 may be a construction company, and an employee of that company can enter project information into input module 105. Entities 110 can include corporate entities, individuals, public agencies, municipalities, utility companies, infrastructure companies, governments, and public/private cooperatives, for example.

Input modules 105 can receive project information from at least one entity 110. For example, entity 110 may be a utility company having a project that relates to gas line repair in a particular neighborhood. In this illustrative embodiment, input module 105 may receive information related to the gas line repair project. This information can include a description of the project and an identification of the entity responsible for the project. Input module 105 can also receive information about the project location, which may include geospatial attributes such as distances, latitude, longitude, altitude or other coordinate data. Input module 105 may also receive information descriptive of a project location based on street addresses, intersections, and natural geographic features such as lakes, rivers, topographical information, or landmark information, as well as location information relative to manmade objects such as dams, bridges, roads, buildings, or other references that can assist in identifying a geographic area or location. Input module 105 may also receive date, time, cost, permit, scheduling, and milestone information related to the project, as well as information related to events that can occur in the same location as the project before, during, or after project implementation. Input module may also receive project information identifying events that are restricted or prohibited before, during, or after project implementation. Input module 105 can receive project information regarding one or more projects associated with one or more entities in text, tabular, audio, visual, or graphical formats where at least one entity 110 is charged with implementation of that project.

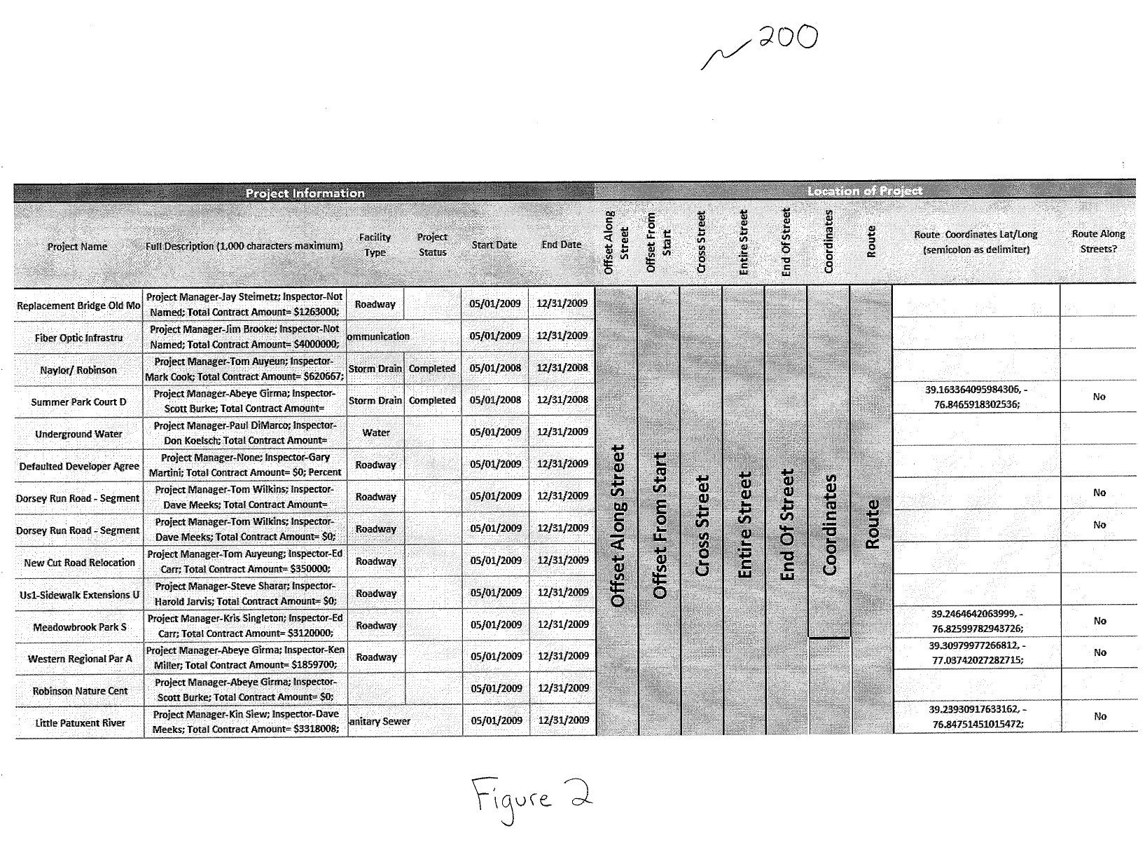

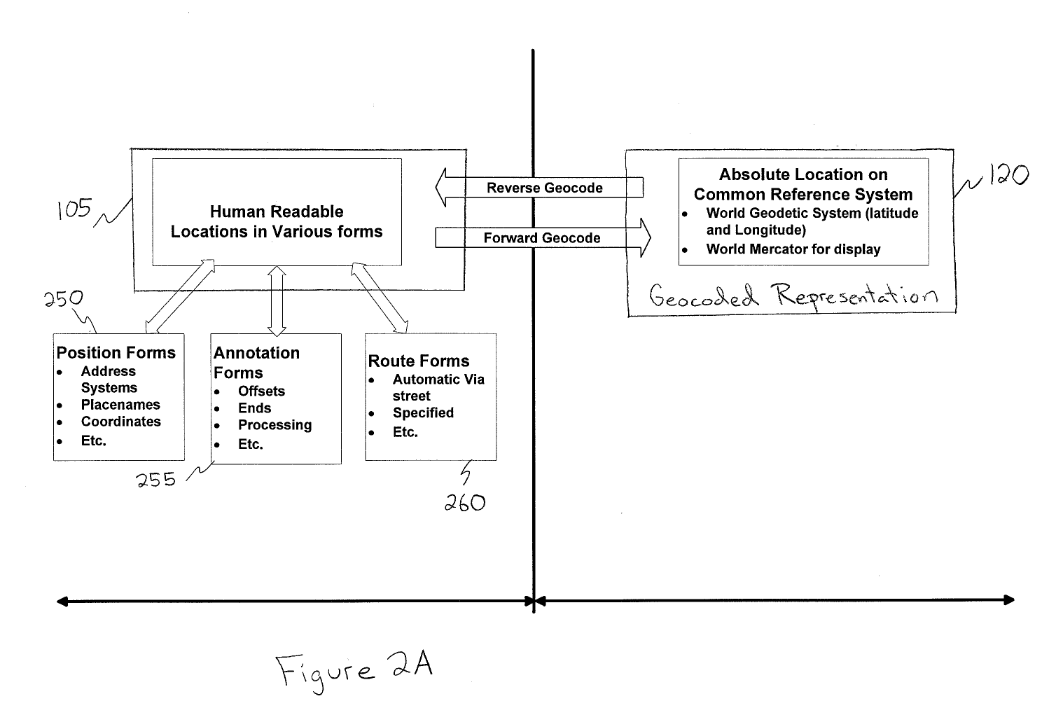

FIG. 2 illustrates a table 200 depicting event coordination in accordance with an embodiment. In one embodiment, table 200 includes project information provided to input module 105. For example, and as indicated in FIG. 2, project information can include a project name, description, type, status, start date, and end date. Project information can also include location information such as offset information from a starting point or along a street. This project information can also include cross street information and information indicating that all or a portion of a street falls within a project footprint. Further, project location information can indicate that a project will continue until the end of a street, or along a certain route, street, or path. As further illustrated in FIG. 2, project location information can include geographic coordinate information. Referring to FIGS. 1 and 2, in one embodiment, table 200 can be provided to entity 110 for data entry purposes.

Returning to FIG. 1, in one embodiment, system 100 includes at least one controller 115. Controller 115 may include a processor or other logic device, and may form part of a computer. For example, controller 115 may form part of a computer together with input module 105. In one embodiment, controller 115 includes input module 105. Controller 115 may also form part of a server in communication with one or more input modules via a local, wide, metro, or other area network such as the Internet.

In one embodiment, controller 115 receives information regarding a plurality of projects from a plurality of input modules 105. For example, input module 105 may receive information regarding a plurality of projects for a municipality. Examples of these projects include new infrastructure projects or existing infrastructure maintenance. Further examples of projects include street or building repair, power, broadband, communications, water, sewer, oil, or gas repair, public park maintenance, sidewalk renovations, bridge, tunnel, or dam work, seawall or levy maintenance, and underwater dredging operations, other infrastructure operations, or human events such as parades, or human street access blockage.

In one embodiment, controller 115 generates at least one geocoded representation 120 of received information. For example, geocoded representation 120 can express project attributes using, at least in part, geographic coordinates or other geographic data. In one embodiment, geocoded representation 120 identifies at least one project and provides project information at least in part in a geographic form. For example, geocoded representation 120 may include a representation of one or more projects in a geographic area, and may include both graphic and tabular elements. In this example, geocoded representation 120 can indicate at least some project information in a grid or map format. Geocoded representation 120 may include a street grid of a neighborhood, town, city, public land, or other geographic area and the project information represented by geocoded representation 120 can indicate the location of the project in the represented area. In one embodiment, geocoded representation 120 can indicate a plurality of projects in juxtaposition with each other. For example, the geocoded representation 120 can indicate temporal or spatial overlaps, or both, of a plurality of projects in an area of geocoded representation 120. In one embodiment, geocoded representation 120 can include imported condition assessments of infrastructure. For example, geocoded representation 120 can include project status attributes such as the age or material of infrastructure such as roadways, power grids, sewer grids, or other physical infrastructure received from one or more entity 110.

In one embodiment, geocoded representation 120 includes project status attributes of at least one project. Project status attributes may include qualities or characteristics of a project, including ownership, temporal, and spatial project information. In one embodiment, project status attributes are associated with characteristics of more than one project. Examples of project status attributes include project information related to project interference, type, location, time, status, conflicts, schedules, milestones, prerequisites, changes, progress, prohibitions, restrictions, approvals, condition, and conflict resolution. Geocoded representation 120 can indicate these and other project status attributes in a graphical, tabular, or textual manner. For example, a project status attribute can be a geographic footprint associated with a project. In this example, geocoded representation 120 can contrast the area of the footprint relative to surrounding areas in geocoded representation 120 to indicate its location. This footprint may be indicated in other ways as well. For example, project status attributes including location information can be indicated in geocoded representation 120 by way of street addresses, or latitude and longitude coordinates, or other geographic indicators. In one embodiment, project status attributes include the condition or a condition assessment of infrastructure. This includes past, present, and estimated future infrastructure (e.g., road network) condition. For example, a future condition level of infrastructure can be estimated or determined, and projects can be implemented based at least in part on infrastructure condition assessments. Further, project status attributes of geocoded representation 120 can include project cost estimates to repair or replace physical infrastructure such as road networks or power grids, or to maintain infrastructure at a predetermined maintenance level.

In one embodiment, entities 110 have varying levels of access to view, edit, add, delete, or modify project status attributes indicated in geocoded representation 120. For example, controller 115 can assign a read-only status to at least one entity 110. An entity 110 with read-only status can view geocoded representation 120 but can be prohibited from making any changes to it. Entity 110 may also be assigned an edit-rights status, where that entity 110 can edit existing project information in addition to viewing at least part of geocoded representation 120.

In one embodiment, entity 110 can be granted restricted access, where that entity can view less than all of geocoded representation 120. For example, an entity 110 with restricted access may only be able to view or edit certain projects or their status attributes (e.g., gas) without being able to view others (e.g., electric). Entities 110 may also be granted full access status, where entity 110 can add, modify, delete, or replace projects for which they are responsible at will. In one embodiment, entities 110 are prohibited from modifying projects associated with other entities 110.

In some embodiments, controller 115 includes security features to ensure secure entry of project information. For example, entities 110 can be provided with at least one owner attribute that may be unique to a particular entity 110. In this example, only entity 110 in possession of this owner attribute can enter information (e.g., project status attributes) regarding one or more projects.

In one embodiment, table 200 includes the project status attributes and other information illustrated in FIG. 2A, which illustrates a block diagram depicting project information for event coordination in accordance with an embodiment. With reference to FIGS. 1 and 2A, input module 105 can receive project information having identifiable locations in a human readable format. Human readable locations, for example, include location understandable to entities 110, including employees thereof. This project information can include geographic indicators and can specify or change locations in regional formats and in existing data. Project status attributes received at input module 105 can include information in various formats. For example, position forms 250 that include address information, placename, or coordinate information, annotation forms 255 that include offsets, end locations, or processing information, or route forms 260 that include street or other specified routes. In one embodiment, table 200 includes information received from position forms 250, annotation forms 255, or route forms 260. One or more entities 110 may provide this information.

With reference to FIGS. 1, 2, and 2A, information from input module 105 may be forward geocoded, for example by controller 115, to generate geocoded representation 120. Geocoded representation 120 may include information from table 200 including absolute or identified geographic locations on a common reference system such as a world geodetic system that uses latitude and longitude or other coordinates. For example, geocoded representation 120 can represent information from input modules 105 in a common system to allow filtering and processing of project status attributes, and to determine project spatial and temporal relationships such as conflicts and opportunities for display. In one embodiment, information in geocoded representation 120 can be reverse geocoded, for example by controller 115, and provided to entities 110.

In one embodiment, project location and other status attributes such as human readable region identifying locations (e.g., addresses) received at input module 105 are translated by controller 115 to generate a geocoded representation 120 that includes corresponding absolute locations on a common reference system (e.g., latitude and longitude coordinates). Project locations represented by geocoded representation 120 may involve one or more positions or routes between those positions, and may have separate or non-continuous segments, which may each form their own geographic area, as indicated.

In various embodiments, human readable locations received by input module 105 can be specified interchangeably as text in, for example, a single compact format or in a multiple entry format such as user interface forms or columns of an import file row. Geocoded representations 120 generated by controller 115 may include absolute locations that are geometry of point, line, polygon, of multiples thereof that can be specified in, for example, a GIS binary format or textual coordinate pairs. Controller 115 can generate geocoded representation 120 by processing, for example, location of addresses, determining street coordinates closest to specified coordinates, transforming street coordinates to addresses, querying offsets and ends of streets along street networks from addresses, or finding routes between specified and derived positions on or off street networks.

In one example, human readable locations may indicate a project location as “text=‘Hillside Ave & Bridge St, Beverly, Mass. 01915: Hillside Ave (North End of Street, Offset Along Street 50 Feet): 42.553286, −70.897867: Hillside Ave & Northern Ave’” and controller 115 may transform human readable formatted location information into geocoded format information such as “shape=‘MULTILINESTRING ((−70.89658999999995 42.55076000000008, −70.89657999999991 42.55088000000006, −70.8966299999999 42.55098000000004, −70.89811525751519 42.55266519658099), (−70.89811525751519 42.55266519658099, −70.897867 42.553286), (−70.897867 42.553286, −70.89875999999992 42.55343000000005))’” to identify the project location. In this example, the geocoded project location information can be indicated in a tabular portion of geocoded representation 120, and represented in a map setting in a graphical portion of geocoded representation 120. It should be appreciated that this is an example, and geocoded representation 120 can use other text and geometric information formats.

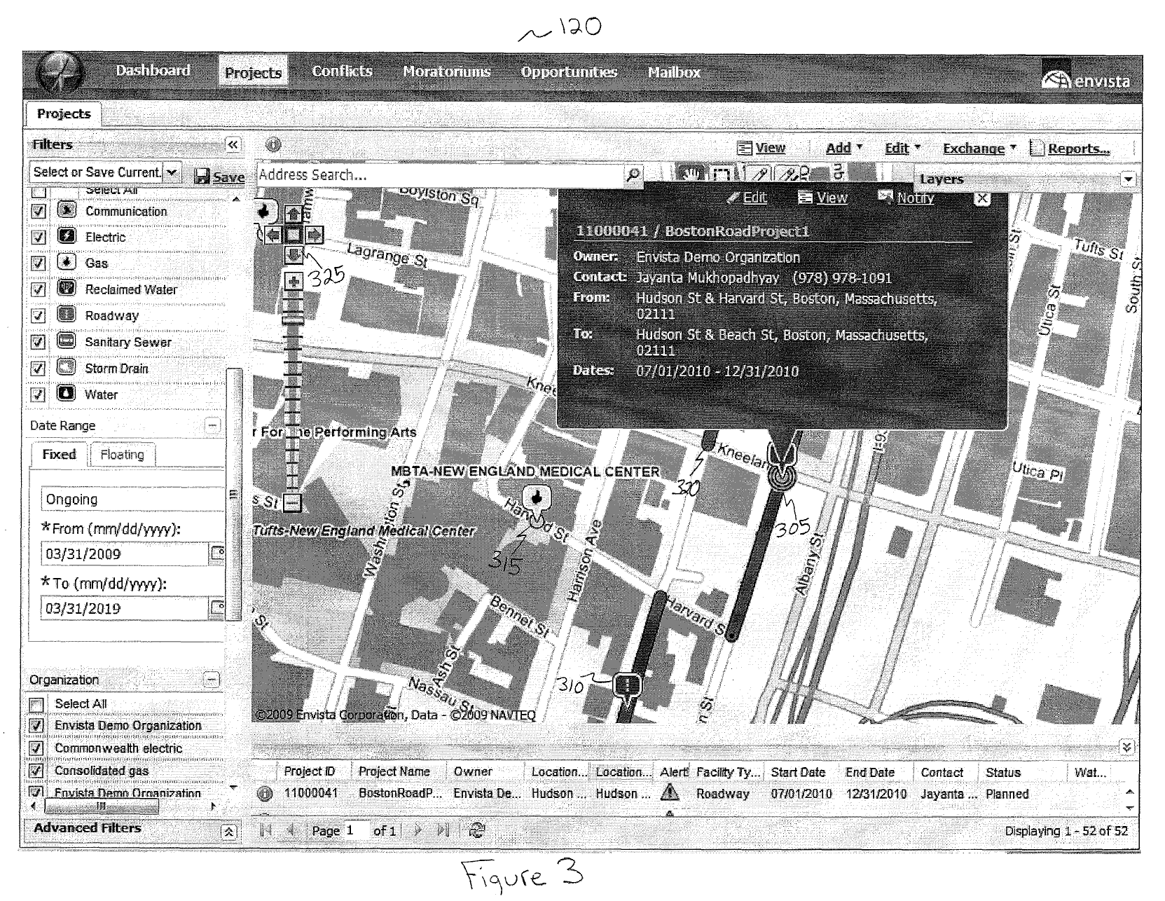

FIG. 3 illustrates an embodiment of a geocoded representation 120 that includes project status attributes. As illustrated in FIG. 3, geocoded representation 120 includes a geographic area having a street grid. With reference to FIGS. 1 and 3, a projects can be identified by shaped geographic areas, icons, windows, tabular information, or combinations thereof that appear on geocoded representation 120. In the embodiment of FIG. 3, it should be appreciated that four projects are identified in geocoded representation 120 with their geographic location indicated at least in part, i.e., projects 305, 310, 315, and 320. Project status attributes of these and other projects can be identified via an icon that can be accessed by entities 110. In the example illustrated by FIG. 3, the icon of project 305 has been opened into a window that includes project status attributes and other information. The project status attributes associated with project 305 include the project name, dates, and contact information. In one embodiment, project status attributes depicted as illustrated in FIG. 3 include additional information, such as information from table 200 of FIG. 2, for example.

With continued reference to FIG. 3, the geographic location of project 310 is partially identified by geocoded representation 120. The icon associated with project 310 is, in this example, a roadway icon as indicated by the tabular information in the left column of geocoded representation 120, identifying project 310 as a roadway project. Analogously, the project icon associated with project 315 indicates that project 315 is a gas project. Further, in the embodiment of FIG. 3, project 320 is partially obscured by the window associated with project 305. It should be appreciated the obscured portion of project 320 and the surrounding street grid are revealed when this window is closed or relocated.

In one embodiment, zoom feature 325 can control geocoded representation 120 so that all or portions of projects such as projects 305, 310, 315, and 320 are indicated within the graphical portion of geocoded representation 120.

In various embodiments, these projects 305, 310, 315, and 320 may be controlled by different entities 110, and each entity 110 may have provided project information without the knowledge of the existence of the other projects in the neighborhood illustrated in FIG. 3, and without coordinating project implementation with any other entity 110. By generating geocoded representation 120, entities 110 can obtain access to and knowledge of projects, (including project status attributes) of which they may have otherwise been unaware. For example, any entity 110 may access project status information of any project (e.g., projects 305, 310, 315, or 320) be opening the project's associated icon.

In one embodiment, geocoded representation 120 as illustrated, for example, in FIG. 3, can be exported to project representations or displays of entities 110. For example, information can be received via input module 105 and a geocoded representation 120 can be generated. In this example, controller 115 can export geocoded representation 120, or portions thereof such as a project location or other project information to entities 110 for display on as part of a project representation that may be, for example, particular to one entity 110.

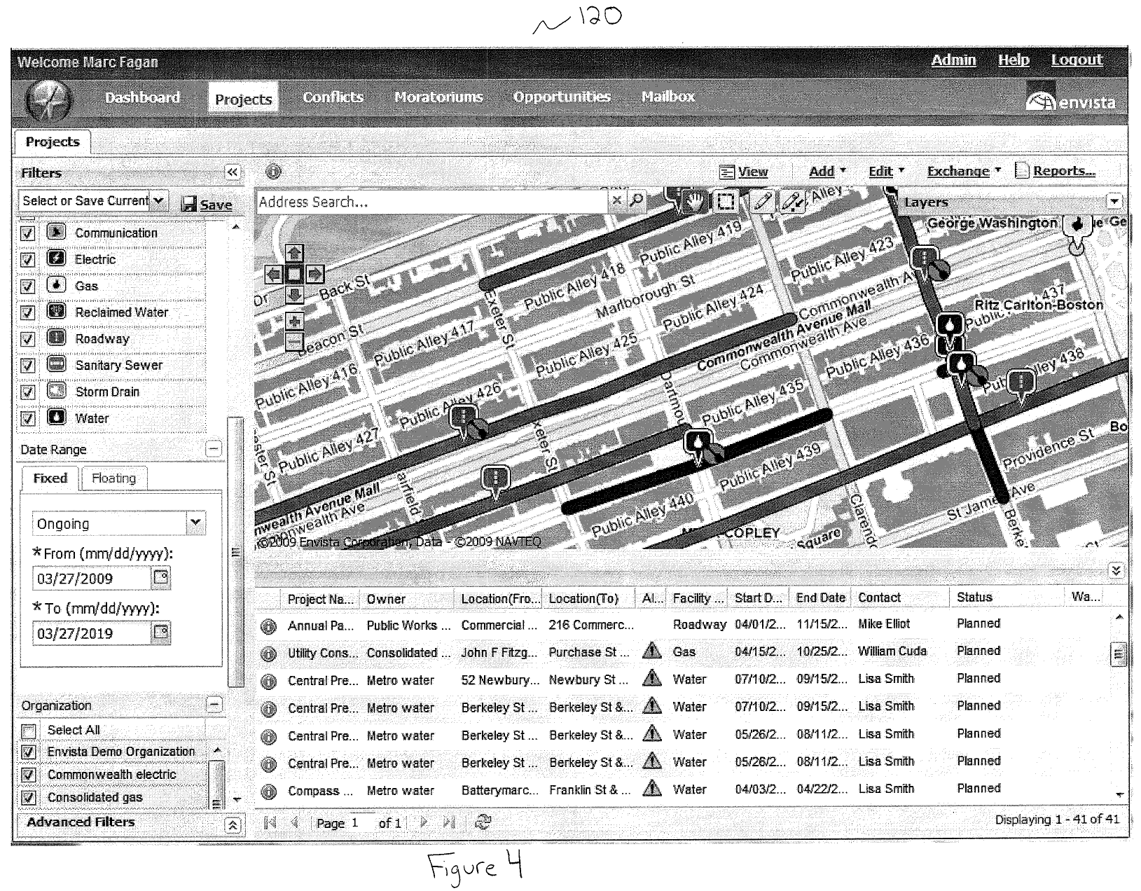

FIG. 4 illustrates another example of geocoded representation 120. As illustrated in FIG. 4, geocoded representation 120 can be presented in a geographical and tabular format. With reference to FIG. 4, the geographical portion, which includes a street grid, graphically illustrates a plurality of projects. It should be appreciated that the project icons in the geographical portion of geocoded representation 120, when read together with the table under the “Projects” tab in the left hand column, indicate the nature of the project graphically indicated by the icon. For example, in the geographical portion of geocoded representation 120, along Commonwealth Avenue, adjacent to the Commonwealth Avenue Mall, two project icons appear. The projects tab, in the tabular portion of geocoded representation 120 and along the left column, indicate that one project is a roadway project, and that another project is a gas project. In this example, project status attribute for these projects can indicate if there is, for example, a conflict between these projects, if one of the projects is restricted or prohibited (e.g., due to a moratorium), or if there is the opportunity for collaboration between the entities 110 responsible for implementation of these projects.

The tabular portions of geocoded representation 120 as illustrated in FIG. 4 include additional project status attributes of a variety of projects. For example, project identification, location, and status information for multiple projects appears in tabular form surrounding the geographic portion of geocoded representation 120. Taken together, geographic and tabular portions of geocoded representation 120 indicate a plurality of project status attributes, such as time, location, type, and status of various projects in a coordinated manner.

With reference to FIG. 1, geocoded representations 120 can be provided to one or more entities 110. As such, one entity 110 becomes aware of the nature, scope, and location of project activity of a different entity 110. In one embodiment, controller 115 provides a geocoded representation 120 that includes project status attributes of at least one project. For example, time or location attributes associated with project implementation can be included in geocoded representation 120 and provided to a plurality of entities 110.

In one embodiment, controller 115 can receive independent information regarding a plurality of projects, where no planning or coordination among entities 110 has occurred with respect to the projects. Controller 115 can evaluate this uncoordinated information to identify conflicting projects. For example, a project by a public works department of a municipality to paint lane markers on a road may be incompatible with a project by a gas company that requires destruction of that same road to access an underlying gas line. In this example the public works road finishing project conflicts with the utility company's gas line repair project. Geocoded representation 120 can display both projects and indicate the nature of the conflict. Geocoded representation 120 may also indicate a potential solution, such as time shifting the road finishing project so that it begins after the gas line repair project is complete. If, for example, this proposed solution is acceptable, geocoded representation 120 can indicate that the conflict has been resolved.

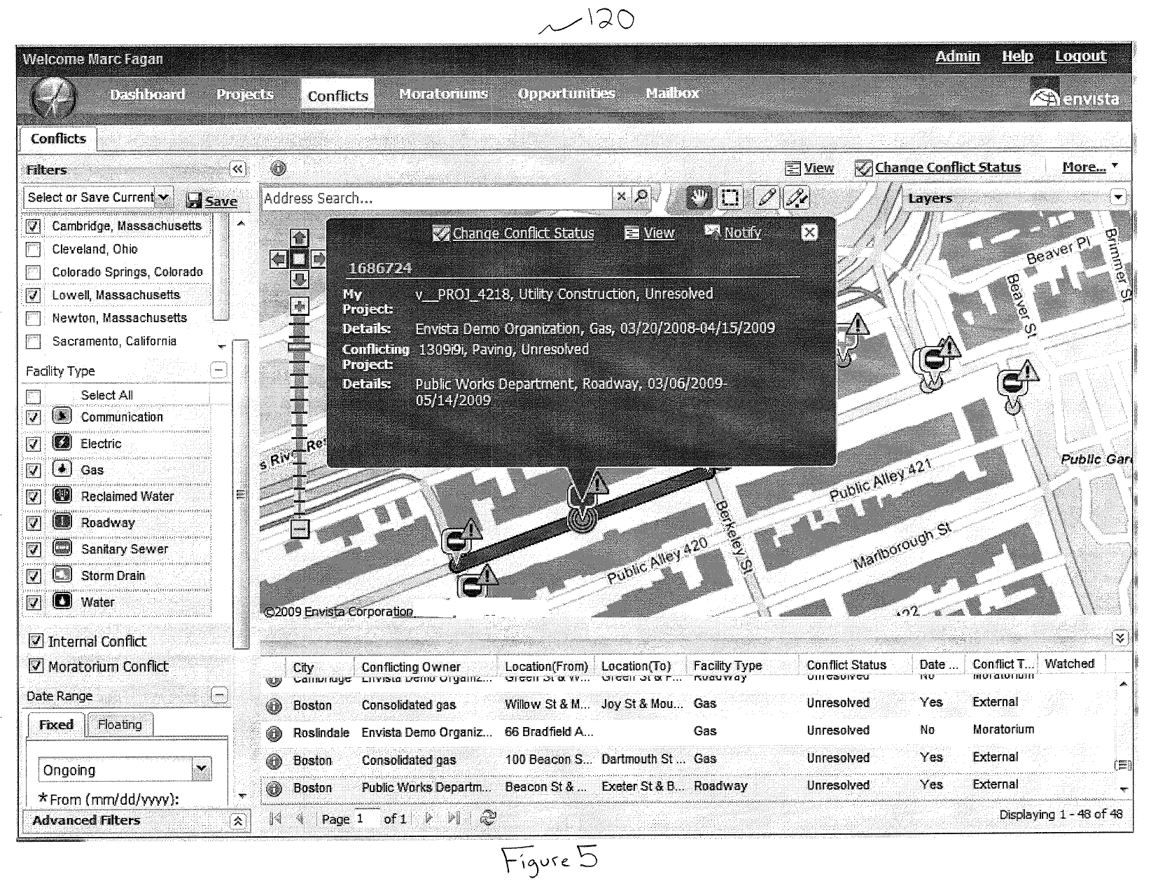

FIG. 5 illustrates an embodiment of geocoded representation 120 depicting an example of conflict between projects. In one embodiment, and as illustrated in FIG. 5, geocoded representation 120 identifies location and sequencing conflicts among projects based on, for example, location, time, type, other projects, planning status, or context of projects relative to governmental planning and authorization. With continued reference to FIG. 5, icons in the geographical portion of geocoded representation 120 can open a window that includes information detailing the nature and status of individual conflicts, and the tabular portion illustrates a plurality of conflicts, their status (e.g., unresolved) and their cause (e.g., moratorium).

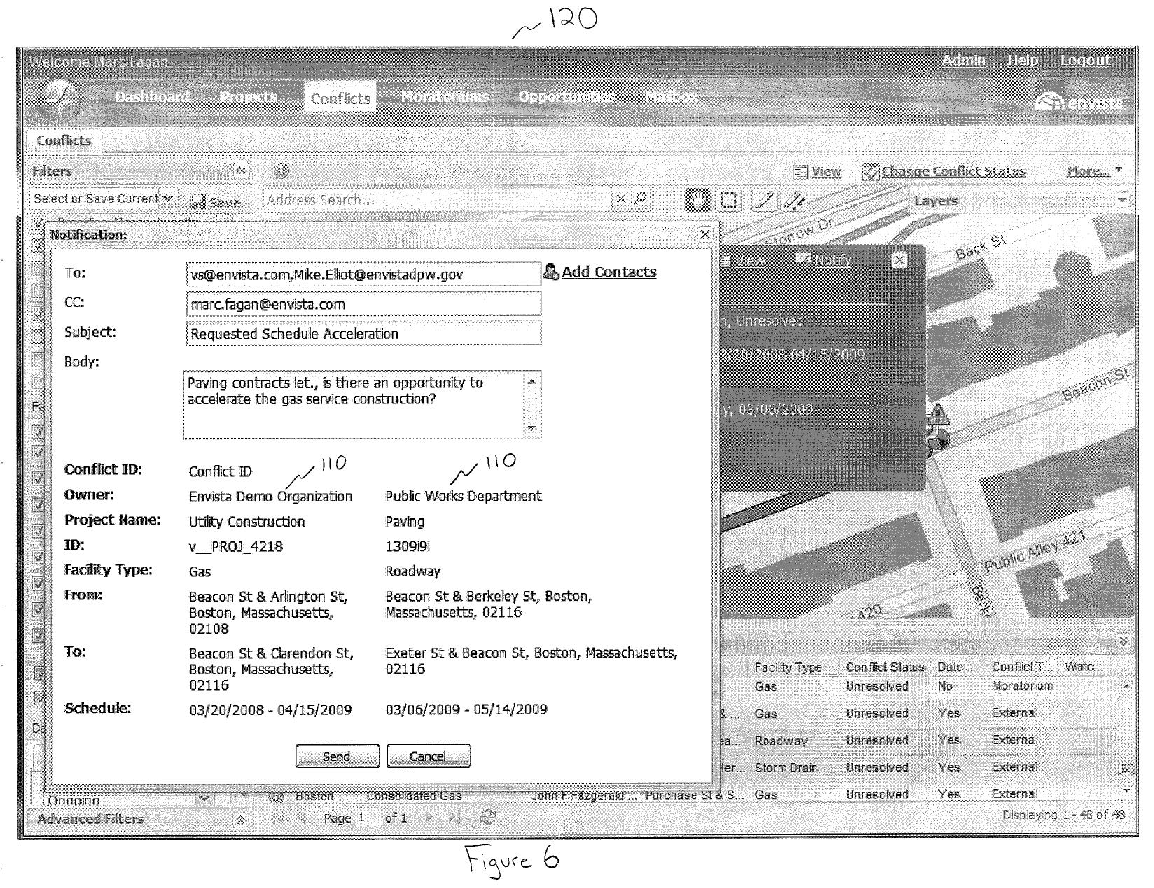

FIG. 6 illustrates a geocoded representation 120 depicting an example of conflict notification. As illustrated in FIG. 6, geocoded representation 120 can notify entities 110 of project conflicts. For example, a conflict may exist between a project of a first entity 110 (e.g., “Envista Demo Organization”) may communicate with a second entity 110 (e.g., “Public Works Department”) regarding the existence of a conflict or a potential solution. As illustrated in FIG. 6, geocoded representation 120 can provide for electronic (e.g., email) communication between entities 110 regarding projects and project status attributes.

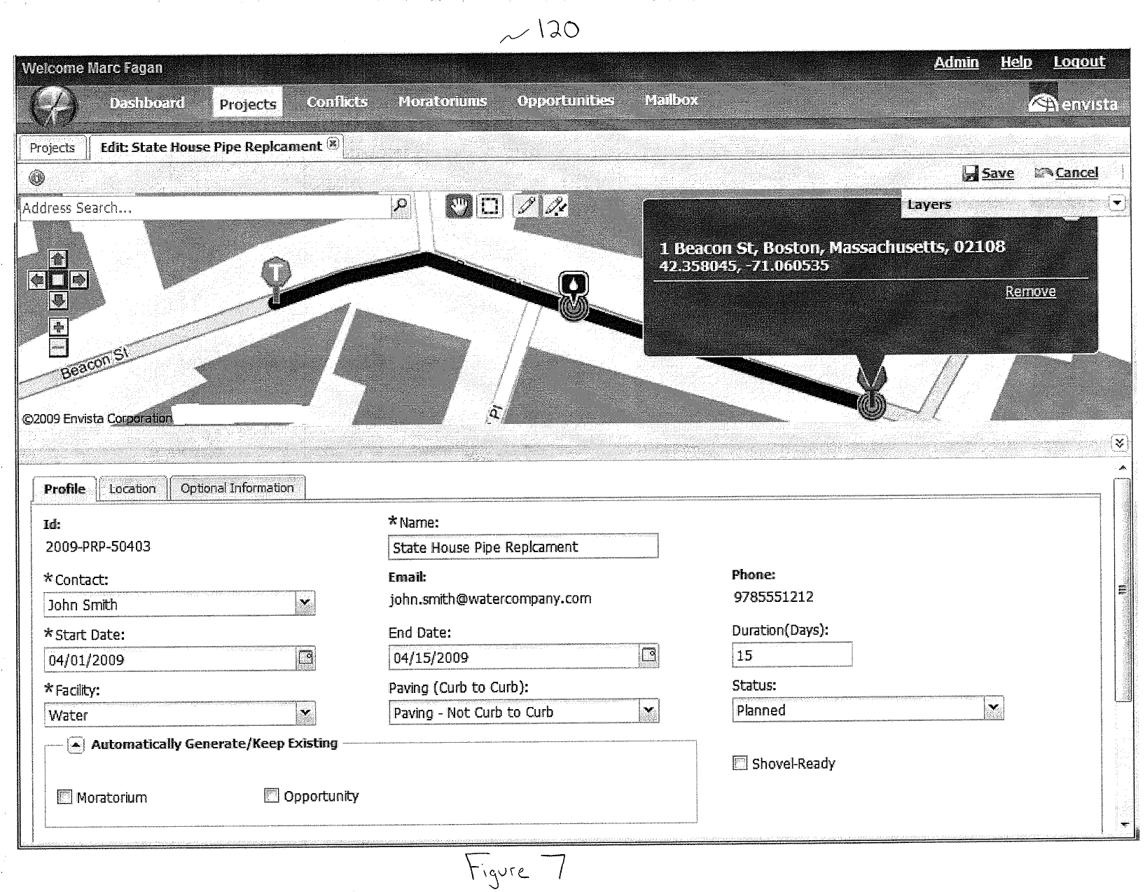

FIG. 7 illustrates a geocoded representation 120 depicting an example of conflict resolution and planning. As illustrated in FIG. 7, entities 110 with projects in conflict can analyze project attributes of the conflicting projects. In one embodiment, these project attributes can be modified to avoid conflict or to create opportunities for cooperation between entities 110. For example, changing the nature of a paving project status attribute such as its construction date may avoid a conflict with other projects.

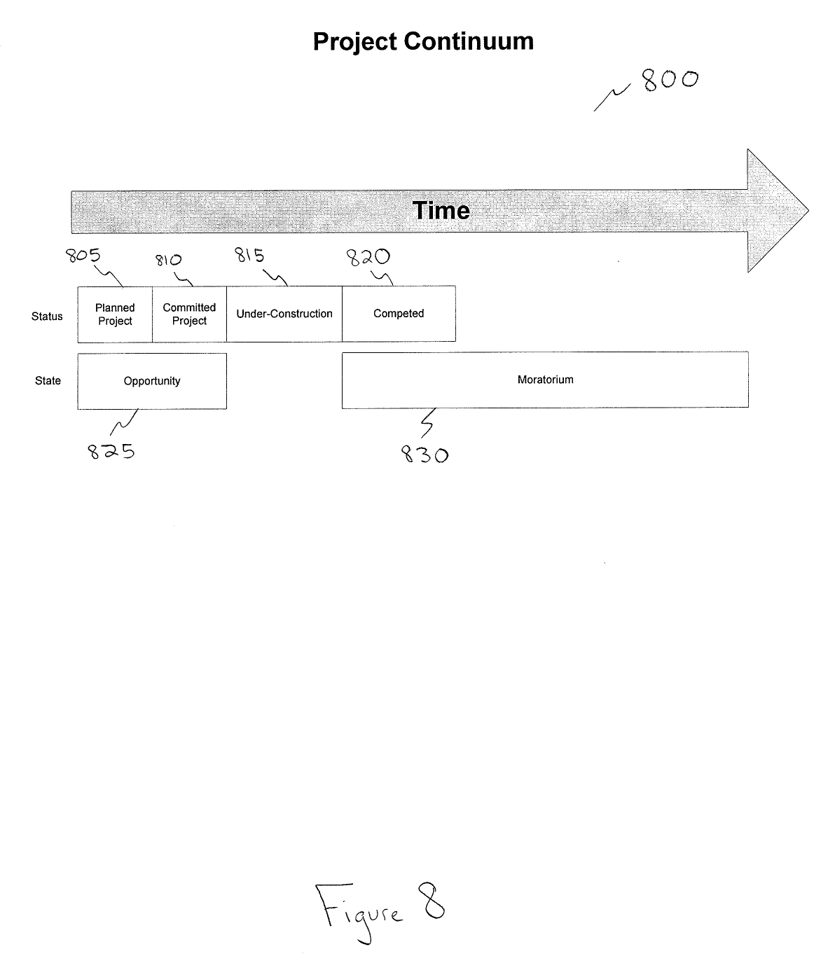

In one embodiment, controller 115 can track changes to project status attributes, and geocoded representation 120 can include these changes. For example, geocoded representation 120 may identify the geographic location of a project and include time attributes identifying the date that the project is scheduled to commence as illustrated in the project continuum 800 of FIG. 8. In this example, when the project commences, the project status attribute may change from a status of a planned project 805, or committed project 810, to a status of under construction 815. Geocoded representation 120 can indicate the changed project status attribute so that a plurality of entities 110 are aware that project construction has commenced. In one embodiment, controller 115 receives information from entity 110 (via for example input module 105) updating project status attributes, although this need not always be the case. For example project status attributes indicated in geocoded representation 120 may change with time, without the need to receive revised project information.

In one embodiment, geocoded representation 120 can notify entities 110 of changes made to project status attributes. For example, controller 115 can detect a changed project status attribute, and can broadcast this change to one or more entities 110, including the entity 110 responsible for the changed project status attribute as well as additional entities 110. In one embodiment, a first entity 110 may indicate a desire to monitor or track one or more projects associated with any entity 110. Continuing with this embodiment, controller 115 can identify a changed project status attribute and notify (e.g., via email) the first entity 110 of the change. This notification may allow first entity 110 to identify conflicts, opportunities, and other information attributable to the changed project status attribute. In some embodiments, controller 115 can notify entities 110 of opportunities, conflicts, or moratoriums that would come into being if a project status attribute were to change in the future. As such, entity 110 may plan for potential projects.

In one embodiment, project attributes indicated in geocoded representation 120 include at least one schedule. Schedules may be indicated in graphical, tabular, or textual formats, or combinations thereof, and schedules may include project implementation and other information provided by more than one entity 110. Schedules may indicate individual dates or time periods. For example, geocoded representation 120 may include a link, table, or drop down window that provides a schedule. Schedule time periods may indicate time attributes identifying the project as a planned project where for example environmental or regulatory reviews are pending, or a committed project (e.g., project approval has been granted and a start date has been set). With reference to FIG. 8, a schedule may also indicate an ‘under construction’ status 815 where project implementation is in progress, or a ‘completed’ status 820 that identifies a projected end date, or identifies that a project has indeed been completed.

Schedules may include further project status attributes. For example, a schedule that is part of geocoded representation 120 can include opportunity 825, moratorium 830, and other time periods. Opportunity time periods can indicate when entities 110 other than the entity 110 responsible for the project have an opportunity to leverage the project of the responsible entity 110 for their benefit. For example, geocoded representation 120 may indicate that a first entity 110 (e.g., the gas company) has a project to repair a gas line in an area that runs beneath the 200 block of Main Street. This project may require excavation of a portion of Main Street. In this example, the time period during which Main Street is excavated may include an opportunity period, where other entities can take advantage of this excavation. For example, a second entity 110 (e.g., the water company) may wish to perform maintenance or inspection of a water main that runs under the 200 block of Main Street, (i.e., implement a project). During the excavation of Main Street, an opportunity exists for the second entity 110 to implement their project without requiring a subsequent, and perhaps costly or prohibited excavation of the same stretch of road. By coordinating project information in this manner, entities 110 can collaborate and cooperate in the planning and implementation of infrastructure projects in overlapping, partially overlapping, adjacent, or separate geographic areas.

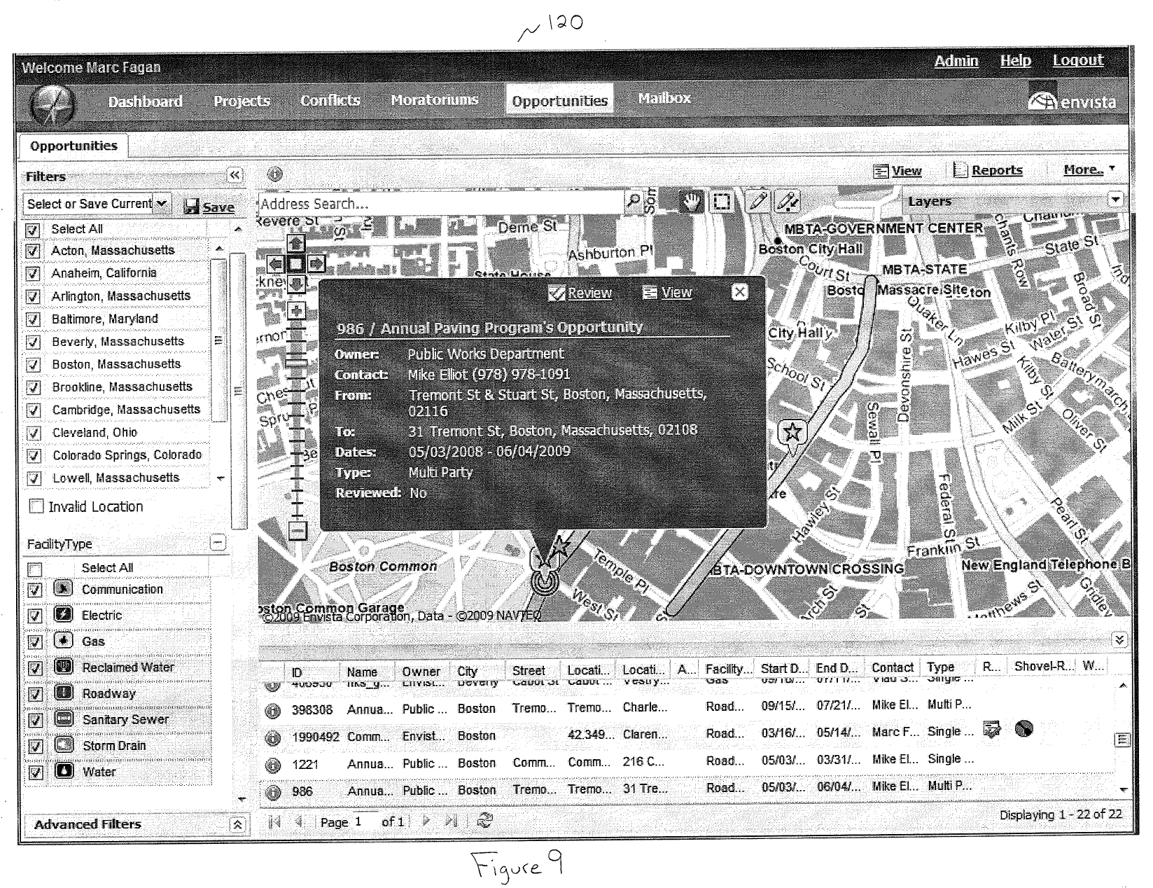

FIG. 9 illustrates a geocoded representation 120 depicting an example of an opportunity. As illustrated in FIG. 9, an icon in the graphical portion of geocoded representation 120, when opened, indicates an opportunity for projects at a geographic location. For example, a road paving opportunity may exist due to the implementation of other projects. With reference to FIGS. 1 and 9, geocoded representation 120 can broadcast an opportunity to, for example, all entities 110 who have contributed information embodied in geocoded representation 120, or to subsets of entities 110. In one embodiment, and with reference to FIGS. 1 and 6, a first entity 110 can directly contact individual entities 110 to indicate the existence of an opportunity for project collaboration.

In one embodiment, project status attributes that may be indicated in schedules or other geocoded representation 120 features include at least one moratorium period. Moratorium periods can indicate that an activity is prohibited or restricted in a geographic area for a period of time. For example, a first entity 110 may include a public works department responsible for a project that includes paving the 400 block of Main Street. In this example, a second entity 110 may include a utility company responsible for a project that includes examining subterranean gas lines located beneath the 400 block of Main Street. It should be appreciated that it may not be in the interest of the public works department or the public at large for the utility company to excavate the 400 block of Main Street relatively soon after the public works department paved that same block. In this scenario, entities 110 and the public may be better served if the utility company excavates Main Street first, and then the public works department repaves the road. To avoid implementing one project that negates the benefits of another project, an authorized entity such as a government may declare a moratorium period, where for example entities 110 can be prohibited from excavating the 400 block of Main Street for a period of time after, for example, a paving project is completed. In this example, the utility company may have restricted or prohibited access to at least some of their infrastructure on a geographic area during the moratorium period.

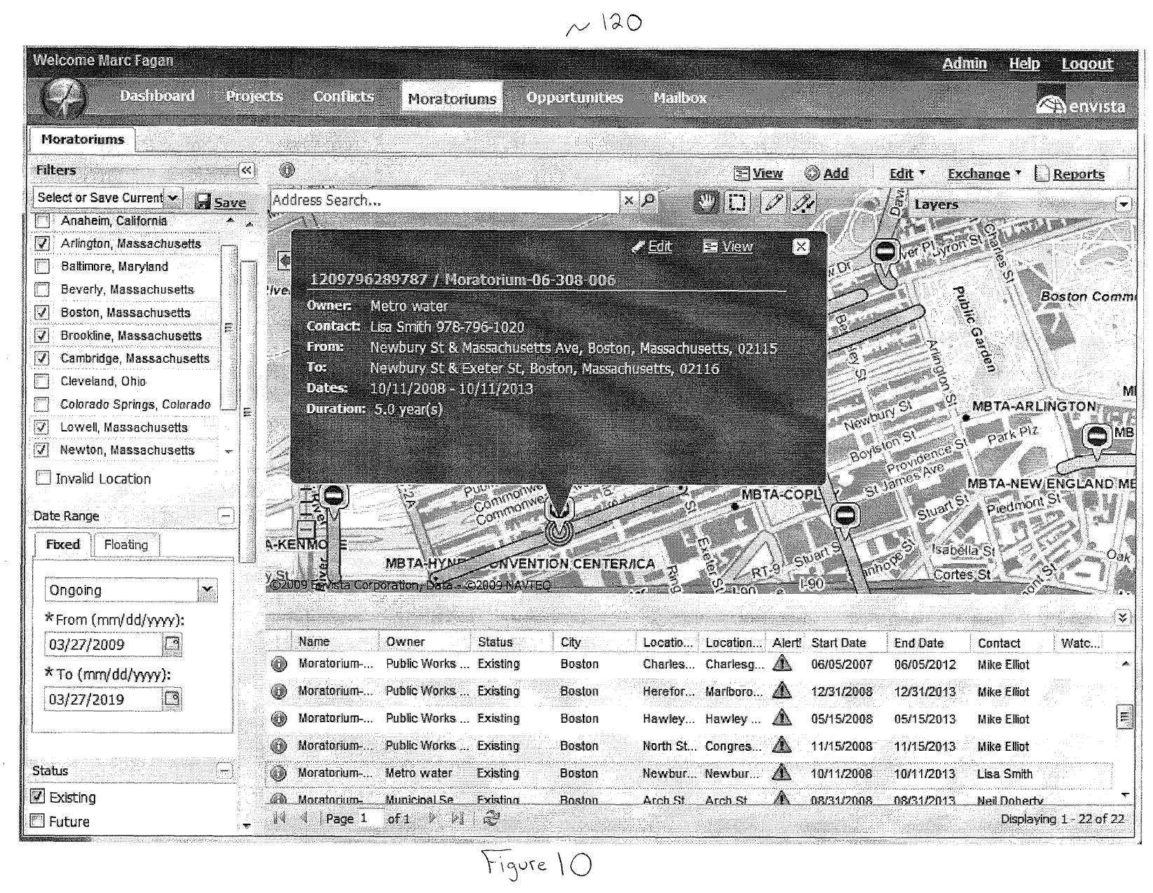

FIG. 10 illustrates a geocoded representation 120 depicting an example of a moratorium. As illustrated in FIG. 10, an icon in the graphical portion of geocoded representation 120, when opened, indicates a moratorium for projects at a geographic location during a time period. Due, for example, to a prior paving project, and as illustrated in FIG. 10, a water infrastructure project along Newbury Street from Massachusetts Avenue to Exeter Street (as indicated in the graphical portion of geocoded representation 120 and in the window) is prohibited during a five year moratorium period. During this moratorium period, for example, entity 110 identified as “Metro water” in the window of the geocoded representation 120 of FIG. 10 can be prohibited from damaging pavement at the identified location when accessing water infrastructure that may lie beneath the pavement. It should be appreciated that his moratorium may render implementation of the water project impossible or not cost effective. The advance notification of the moratorium provided by geocoded representation 120 enables entities 110 to identify project implementation problems and alternatives at an early stage of a project planning process.

As illustrated in FIGS. 3-7, 9, and 10, geocoded representation 120 can indicate the location, time, and nature of a plurality of projects from multiple entities 110 over a geographic location such as a city. For example, entity 110 such as a public works department may have a plurality of planned paving projects for a city. To minimize disruption and cost, and otherwise efficiently plan project implementation, geocoded representation 120 can be provided to the public works department, among other entities 110. Geocoded representation 120, in this example, can indicate the nature and location of a plurality of planned, ongoing, and completed projects in the city and concentrated clusters of these projects may become evident. These projects include public works department projects as well as projects from other entities 110. For example, geocoded representation 120 can indicate that construction company 110 is scheduled to begin construction of a private residential and commercial complex in an identified location. Geocoded representation 120 can further indicate that this construction project entails a temporary road closure of a street adjacent to the construction site. In this example, the period of the temporary road closure can include an opportunity period for a public works department or other entity 110 to implement any projects planned for that road. In this example, two different projects can be implemented by two different entities, during a single road closure.

Geocoded representation 120 can also indicate conflicts between projects or among entities 110. For example, geocoded representation 120 can provide the location of planned public and private infrastructure projects for a city, and these projects can overlap in time and in geographic location. Some of these overlaps may cause conflicts, as two entities 110 may not be able to implement different projects at the same time, or at different times within an overall time period, (such as a moratorium period). Further, two entities 110 may not be able to implement different projects in the same geographic location, or at different locations (e.g., parallel streets) when doing so may inconvenience others. Geocoded representation 120 can provide notification of these conflicts to entities 110. This notification can be indicated by geocoded representation 120, or may be provided in another manner, such as by email or other electronic communication. In one embodiment, entities 110 notified of conflicts include those responsible with implementation of a conflicting project, as well as unaffiliated entities 110. Geocoded representation 120 can suggest resolutions to conflicts, for example by suggesting time-shifting implementation of one or more projects, and geocoded representation 120 can indicate that conflicts have been resolved.

System 100 may also include at least one display 125. Display 125 may include a monitor, and can be a stand alone device or part of a computer, personal digital assistant, mobile telephone, or other device. In one embodiment, input module 105 and display 125 form part of a computer that includes or communicates with controller 115. For example, entities 110 may provide project information via input module 105 into a computer, and geocoded representation 120 can be provided to display 125 where it can be accessed by entity 110.

In one embodiment, controller 115 forms part of an asset management system having a data store such as a memory device or a storage element that includes information from geocoded representation 120. An example of this information includes a periodic condition assessment of a utility network, road network, or other tangible infrastructure asset. Geocoded representation 120 can include a model of the infrastructure asset and a user interface, for example at display 125, and can associate the infrastructure asset with the model in geocoded representation 120. In this example, controller 115 can use the model included in geocoded representation 120 to create an activity scenario of the infrastructure asset based, for example, on the information in the data store and a future physical condition level of the infrastructure asset. In one embodiment, this activity scenario is conditional, indicating what would happen to infrastructure based on future condition levels. For example, geocoded representation 120 can indicate potential projects, responsive to the activity scenario, and provide these potential projects to entities 110. These potential projects can include one or more recommended activities, such as repair, replacement, maintenance, preservation, or improvement, and geocoded representation 120 can include alternative project scenarios associated with potential future condition levels of infrastructure or other tangible assets, as well as budget or financial information. In one embodiment, models included in geocoded representation 120 include cross sectional infrastructure (e.g., roadway) design information

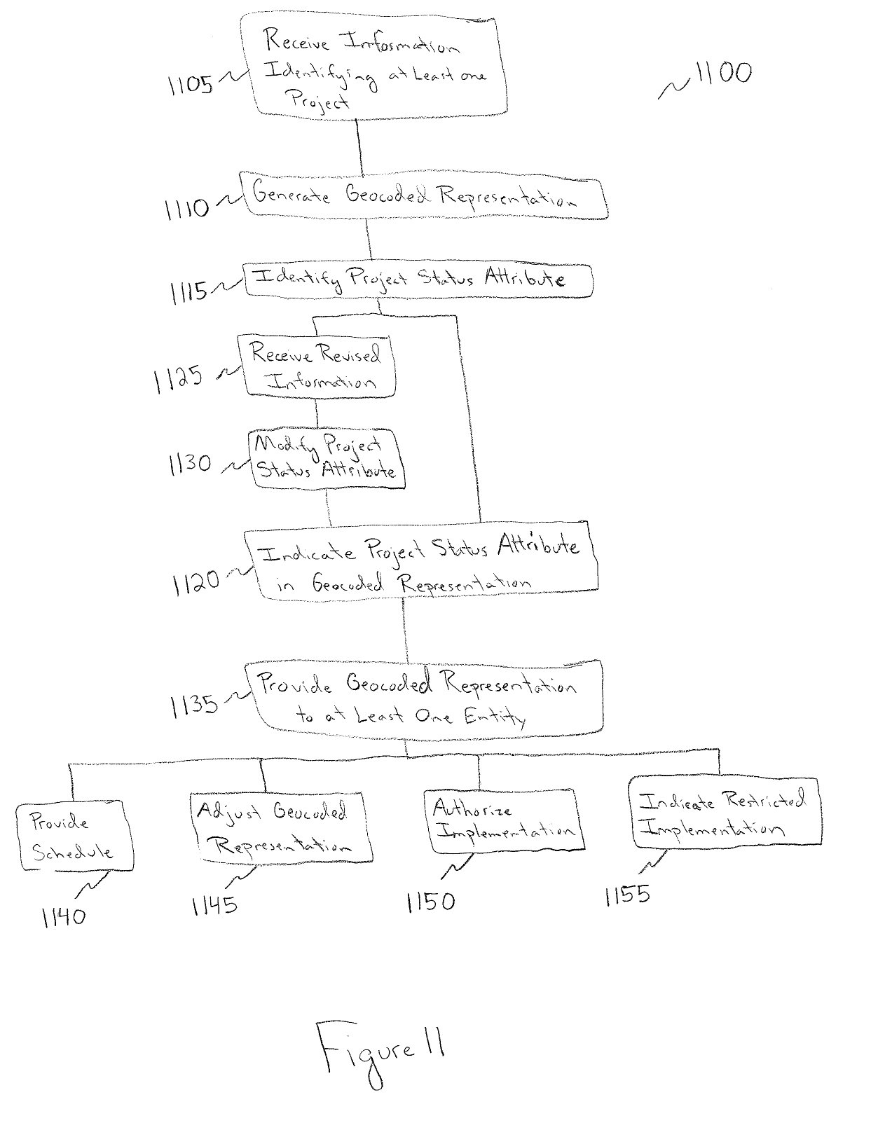

FIG. 11 is a flow chart depicting a computer implemented method 1100 of event coordination in accordance with an embodiment. Method 1100 includes an act of receiving information identifying at least one project (ACT 1105). In one embodiment, receiving information (ACT 1105) includes receiving information identifying a first project and information identifying a second project. For example, receiving information (ACT 1105) may include receiving information about a project from an entity.

Receiving information identifying at least one project (ACT 1105) can include receiving information in a geographic information system (GIS) compatible format. For example, receiving project information (ACT 1105) may include receiving information linked to a geographic location of the project. In this example, receiving project information (ACT 1105) may include receiving information identifying the location of a project, (for example a construction project) by geographic coordinates, street address or range of addresses, postal codes, landmarks, or other features indicative of geographic location.

In one embodiment, receiving project information (ACT 1105) can include receiving information from a plurality of users regarding a plurality of projects. For example, users such as utility companies, service providers, municipal agencies, or private construction firms can each enter information regarding a variety of projects. Receiving project information (ACT 1105) may include receiving information that indicates the nature, time frame, or location of the project, or contact information of an entity responsible for project approval or implementation. In one embodiment, the information that is received (ACT 1105) may be entered via a shapefile or other geospatial vector data format that may be compatible with a geographic information system. The information that is received (ACT 1105) may also be entered in a comma separated value or other data format for tabular information data entry.

In one embodiment, receiving project information (ACT 1105) includes receiving data via a user interface, such as a computer and associated peripheral devices, (e.g., monitor, mouse, touchpad, or keyboard). For example, receiving information identifying at least one project (ACT 1105) may include receiving information entered directly via a system user interface, or via the Internet in, for example, a keyhole markup or other extensible markup language based scheme that can express geographic based information in two or three dimensional maps.

Method 1100 in one embodiment includes receiving project information (ACT 1105) about a plurality of projects where the information between projects is uncoordinated information. For example, information may be received (ACT 1105) from a first entity and independently received from a second entity so that neither entity has an awareness of the others information. This uncoordinated information may indicate that the projects are scheduled for the same geographic area, or to occur in a time or manner that causes a conflict.

In one embodiment, method 1100 includes at least one act of generating a geocoded representation (ACT 1110). In one embodiment, generating a geocoded representation (ACT 1110) includes generating a geocoded representation of the information identifying at least one project. For example, generating a geocoded representation (ACT 1110) may include generating a representation of at least one project that includes geospatial attributes such as distance, length, width, latitude, longitude, altitude, date, local or global time, or other coordinate reference system. In one embodiment, generating a geocoded representation (ACT 1110) includes generating a representation of a project, where the representation includes geographic data such as street names or addresses, geological features such as hills, ridges, rivers, lakes, or coastline, or man made features such as buildings, roads, dams, landmarks, train tracks, walkways, or other objects capable of identifying a geographic location. These attributes and geographic features may be displayed in a graphical, tabular, or mixed environment.

In one embodiment, generating a geocoded representation of project information (ACT 1110) includes identifying the location of at least one project. For example, the geocoded representation of a project such as one that involves work on a below-ground gas line may indicate the location where digging will be necessary to access the gas line. This location may be identified via various geographic indicators such as the geospatial attributes or geographic data referenced above. Generating a geocoded representation of project information (ACT 1110) can include indicating a buffer area associated with the project. For example, if the project includes sidewalk repair of an identified length of sidewalk, the location of that project may include a portion of the street that is adjacent to the sidewalk. In this example, generating the geocoded representation of project information (ACT 1110) includes a representation of the project that identifies the area to be impacted by implementation of the project, (e.g., its footprint).

In one embodiment, generating the geocoded project representation (ACT 1110) includes generating the project representation in at least one of a tabular format and a geographic format. For example, generating a geocoded representation (ACT 1110) may include generating project representations that include both tabular and geographic information. For example, a geocoded representation of a project, when displayed, may include a map identifying geographic areas associated with projects, as well as tabular information that may also indicate the geographic area, for example by address or coordinate information. The geographic and tabular information may also include non-geographic information that indicates the nature, scope, or extent of the project, for example. In this example, a geographic display of the geocoded representation may visualize where on a street grid a project is scheduled, and an accompanying tabular display may indicate the corresponding street addresses as well as additional project information, such as dates, scope, administrative information, or the nature of the project.

Generating geocoded representations that include graphic and tabular representations of projects (ACT 1110) in one embodiment includes generating a geocoded representation that includes time attributes of at least one project. For example, generating geocoded project representations (ACT 1110) may include providing time attributes associated with implementation of one or more projects. These time attributes in the geocoded representations may indicate estimated or actual project beginning and end dates, achieved or targeted milestones, implementation schedules, and other time windows. In one embodiment, generating a geocoded representation (ACT 1110) includes providing time attributes such as opportunity periods, moratorium periods, and public comment periods, and associating these periods with a project or geographic area.

In one embodiment, generating a geocoded representation (ACT 1110) includes generating a geocoded representation of an area that may include one or more actual or proposed projects as well as manmade or natural geographic features such as street grids, infrastructure networks, rivers, or forests. Generating geocoded representations (ACT 1110) may include juxtaposing geographic areas associated with multiple projects in the geocoded representation. For example, a cluster, or area associated with multiple projects, may be identified as such in the geocoded representation. These areas may overlap at least in part, or they may be contiguous, adjacent. In one embodiment generating the geocoded representation (ACT 1110) includes juxtaposing geographic areas and their associated projects where the geographic areas do not overlap and are separated by an intervening geographic area.

In one embodiment, generating the geocoded representation (ACT 1110) includes translating between human readable region specific locations (e.g., addresses) and the absolute locations on a common reference system (e.g., latitude and longitude coordinates) to identify project location and other status attributes. For example, project location may involve one or more positions or routes between those positions, and may have separate or non-continuous segments, which may each form their own geographic area. In this example, the geocoded representation may be generated (ACT 1110) to indicate multiple locations of one project.

Method 1100 may also include at least one act of identifying project status attributes (ACT 1115). Identifying project status attributes (ACT 1115) may include descriptors indicative of the status of all or part of at least one project. In one embodiment, identifying project status attributes (ACT 1115) includes identifying project status attributes of at least one project based at least in part on the received (ACT 1105) information identifying the project. For example, identifying a project status attribute (ACT 1115) may include identifying dates associated with a project implementation schedule, schedule milestones, initiation or completion dates, date ranges, project conflicts, project changes, conflict resolutions, and potential or actual factors that may interfere with project implementation or delay or expedite project completion. Identifying project status attributes (ACT 1115) can include identifying or tracking changes to project status attributes, and entities may be notified of these changes to, for example, monitor or track the planning and implementation of various projects as well as presenting project implementation schedules to entities.

In one embodiment, identifying project status attributes (ACT 1115) includes identifying future oriented attributes. For example, identifying project status attributes (ACT 1115) may include identifying an opportunity period for a second project to overlap in time or space with a first project. Identifying project status attributes (ACT 1115) may also include identifying a moratorium time period during which time implementation of one or more projects can be at least partially prohibited from a geographic area associated with a project. The moratorium time period may extend, for example, beyond the completion date of a project, and may begin before, during, or after the implementation of a project.

In one embodiment, identifying project status attributes (ACT 1115) includes identifying a project status attribute of at least one project based at least in part on the received (ACT 1105) information identifying the project or projects. For example, method 1100 may include receiving information (ACT 1105) identifying one project scheduled for the 1600 block of Main Street and identifying another project on the 100 block of Wall Street, where Wall Street and Main Street intersect. A geocoded representation of this information may be generated (ACT 1110), indicating, for example, at least a partial overlap in the areas associated with the two projects. Continuing with this example, project status attributes may be identified (ACT 1115). For example, if the received information (ACT 1105) indicates that the two projects are scheduled for the same time, method 1100 may identify a project status attribute (ACT 1115) that identifies a conflict between the two projects.

There are various forms of conflict. For example, a project status attribute identifying a conflict (ACT 1115) may be due to a lack of space for the equipment associated with each project, such as surface treatment or milling machines, digging or other industrial equipment or trucks. A project status attribute identifying a conflict (ACT 1115) may also be due to spatial overlap in, for example, infrastructure that is the subject of the projects. With reference to the above-illustrated example, a project to resurface Main Street and a project to repair a pipe beneath Wall Street may conflict at the intersection of these streets, as it is appreciated that the overlapping region of these streets cannot be resurfaced before or during the time that it is removed to access a pipe that lies beneath that region.

A project status attribute identifying a conflict (ACT 1115) may be due to municipal concerns, when at least partially overlapping projects may otherwise be compatible in space and time. For example, projects at Main Street and Wall Street may be capable of simultaneous implementation, however they may each require closure of a non-overlapping portion of their respective street, which may disrupt traffic patterns in a way that is unacceptable to a municipality. In this example, a conflict may be identified (ACT 1115) where the conflict is related to the effects of project implementation, (e.g., surrounding traffic pattern disruptions) as opposed to the implementation of the projects themselves, which in this example are not in physical conflict. In one embodiment, a conflict or other project status attribute between two or more projects can be identified (ACT 1115) when the projects are in separate geographic areas that, as indicated in the received information (ACT 1105), are in this example free of spatial and/or temporal overlap.

Method 1100 in one embodiment includes an act of indicating the project status attribute in the geocoded representation (ACT 1120). For example, project status attributes indicating the status of the project, for example budgetary matters, time until project work begins or ends, or the current status of the work during project implementation, can be included in the geocoded representation of the project. In one embodiment, indicating the project status attribute (ACT 1120) includes indicating project status information in a tabular or geographic format. For example a display of the geocoded representation may include a street grid of a municipality that indicates a footprint area of this project. A project status attribute for projects in this area may, for example, be color coded, or indicated by a particular marker, icon, font, text, or background, for example. The project status attribute may be indicated (ACT 1120) in a manner that is hidden from the geocoded representation, and may be revealed by, for example, clicking on an icon or part of the area identified as being associated with a project, scrolling a cursor over an area of the geocoded representation, or locating a table that is part of the geocoded representation and associated with a project.

Method 1100 includes acts of receiving revised information (ACT 1125) and modifying project status attributes (ACT 1130). In one embodiment, method 1100 may receive revised information (ACT 1125) responsive to acts of identifying project status attributes (ACT 1115) or indicating project status attributes in the geocoded representation (ACT 1120). For example, an entity such as a department of public works may provide information about an infrastructure project indicating that the project status attribute is roadwork scheduled for implementation in six months (ACT 1120). Another entity, such as a utility company, may provide information about another project may currently be taking place in a geographic area that includes the same road. For example, the utility company may be repairing utility poles and above ground wires alongside that road, with a project status attribute indicating (ACT 1120) that this work is in progress and scheduled to continue for nine months. In this example, method 1100 may receive revised information (ACT 1125) from the department of public works changing the estimated start date of the roadwork from six to nine months, and the project status attribute may be modified (ACT 1130) to indicate the revisions.

Modifying project status attributes (ACT 1130) need not be responsive to an act of receiving revised information (ACT 1125). In one embodiment, modifying project status attributes (ACT 1130) includes adding or deleting project status attributes. For example, information received (ACT 1105) may indicate that an opportunity period exists for a time period, and identifying the project status attribute (ACT 1115) may include identifying the opportunity period. In this example, modifying the project status attribute (ACT 1130) may include removing the opportunity period attribute from the geocoded representation upon expiration of the opportunity period. Removed project status attributes may or may not be replaced with new project status attributes.

In one embodiment, method 1100 includes an act of providing the geocoded representation to at least one entity (ACT 1135). For example, geocoded representations including a plurality of projects from one or more entities may be provided (ACT 1135) to those entities via local, wide, metro, or other area networks such as the Internet. Providing geocoded representations (ACT 1135) may include providing the geocoded representation to a display such as a monitor. Providing geocoded representations of projects (ACT 1135) may include providing the representations to public or private entities. For example, geocoded representations may be provided (ACT 1135) to the entity from which information was received (ACT 1105). In one embodiment, information received from one entity (ACT 1105) may be broadcast to that same entity as well as additional entities, including individual users and the public at large (ACT 1135). Providing the geocoded representation (ACT 1135) may enable many different entities to see, in a geocoded format, project plans of other entities, including for example construction details, requirements, timelines, footprints, and conflicts or potential conflicts.

Providing geocoded representations to entities (ACT 1135) can include providing coordinated information regarding multiple projects to at least one entity. For example, uncoordinated information received from two or more entities (ACT 1105) may be presented in a coordinated manner in the geocoded representation and provided to entities (ACT 1135) with identified conflicts, opportunities, moratoriums, opportunities, and schedules. In this example, an entity may be provided with a geocoded representation of projects associated with that entity, as well as other projects from other entities, that have been implemented, are being implemented, or that are scheduled for implementation in the same, a surrounding, adjacent, or non-overlapping geographic area. This information included in the geocoded representation may also include notifications, alerts, and analysis reports.

Method 1100 may include an act of providing a schedule for one or more projects (ACT 1140). For example, tabular or graphical components of the geocoded representation of the project may indicate proposed or actual schedules for project implementation, which may be provided (ACT 1140) to the entity responsible for the project as well as other aligned, competitive, or interested entities. In one embodiment, providing project schedules (ACT 1140) includes printing or electronically providing (e.g., emailing) a report that includes notifications of project status attributes such as time attributes or geographic data associated with one or more projects.

One embodiment includes adjusting the geocoded representation (ACT 1145). For example, adjusting the geocoded representation (ACT 1145) may occur, for example, responsive to receiving project information (ACT 1105), receiving revised information, (ACT 1125), or to modifying project status attributes (ACT 1130). Adjusting geocoded representations (ACT 1145) may include adjusting the representations to indicate changes in projects or their attributes, as well as conflicts, resolutions, opportunities, or moratoriums.

In one embodiment, method 1100 includes an act of authorizing implementation of at least one project (ACT 1150). For example, a project may be authorized for implementation (ACT 1150) when no moratoriums or other conflicts have been identified. Projects may also be authorized for implementation (ACT 1150) when the geocoded representation indicates that regulatory approvals are satisfied, such as environmental approvals or acquisition of permits. In one embodiment, authorizing one project (ACT 1150) triggers changes in project status attributes of that project, as well as other projects. For example, authorizing one project (ACT 1150) may trigger generation of a conflict or other attribute with respect to other projects in overlapping, partially overlapping, or different geographic locations.

Method 1100 includes in one embodiment an act of indicating that implementation of one or more projects is restricted (ACT 1155). For example, indicating that a project is restricted (ACT 1155) may include indicating that a geographic area associated with the project is subject to a moratorium period, or associated with a conflict. In one embodiment, indicating project restriction (ACT 1155) includes indicating in the geocoded representation that government approval or permits are required prior to authorizing project implementation (ACT 1150).

Note that in FIGS. 1 through 11, the enumerated items are shown as individual elements. In actual implementations of the systems and methods described herein, however, they may be inseparable components of other electronic devices such as a digital computer. Thus, actions described above may be implemented at least in part in software that may be embodied in an article of manufacture that includes a program storage medium. The program storage medium includes data signals embodied in one or more of a carrier wave, a computer disk (magnetic, or optical (e.g., CD or DVD, or both), non-volatile memory, tape, a system memory, and a computer hard drive.

From the foregoing, it will be appreciated that the event planning provided by the systems and methods described herein afford a simple and effective way to coordinate project information regarding a plurality of projects from a plurality of entities that may be independent of each other. Projects can be coordinated with one or more other projects and one or more entities, including entities responsible for implementation of any project indicated in the geocoded representation, as well as additional entities. The event coordination according to various embodiments is able to organize the management of region-wide infrastructure and other asset projects. The project status attributes of the geocoded representations identify a plurality of projects, as well as conflicts and opportunities within, between, and among different projects. This increases efficiency and compatibility of project implementation, and lowers cost to companies, governments, and taxpayers.

Any references to front and back, left and right, top and bottom, and upper and lower are intended for convenience of description, not to limit the present systems and methods or their components to any one positional or spatial orientation.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements.

Any embodiment disclosed herein may be combined with any other embodiment, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by references signs, the reference signs have been included for the sole purpose of increasing the intelligibility of the drawings, detailed description, and claims. Accordingly, neither the reference signs nor their absence have any limiting effect on the scope of any claim elements.

One skilled in the art will realize the systems and methods described herein may be embodied in other specific forms without departing from the spirit or essential characteristics thereof. For example, geocoded representations can include project information regarding past projects that have been completed, ongoing projects, or future projects that have not yet commenced. Further, event coordination and asset management can extend beyond infrastructure projects. For example, geocoded representations of factories, buildings, assembly lines, and manufacturing processes can be generated, as well as geocoded representations of other (e.g., financial) transactions that may occur in different geographic locations. These geocoded representations can receive uncoordinated information about a variety of projects or transactions and represent the information, in a geocoded format, in a coordinated manner where points of beneficial or conflicting interaction between different projects can be indicated. The foregoing embodiments are therefore to be considered in all respects illustrative rather than limiting of the described systems and methods. Scope of the systems and methods described herein is thus indicated by the appended claims, rather than the foregoing description, and all changes that come within the meaning and range of equivalency of the claims are therefore intended to be embraced therein.

What is claimed is:

1. An event coordination system, comprising:
an input module configured to receive information identifying a first project and information identifying a second project;
a controller configured to generate a geocoded representation of the information identifying the first project and the information identifying the second project;
the controller further configured to identify a project status attribute of at least one of the first project and the second project based at least in part on the information identifying the first project and the information identifying the second project; and
the geocoded representation including an indication of the project status attribute.

2. The system of claim 1, wherein the controller is configured to provide the geocoded representation to a display, the geocoded representation identifying the first project and the second project in at least one of a tabular format and a geographic format.

3. The system of claim 1, wherein the controller is configured to provide the geocoded representation with time attributes associated with an implementation schedule of at least one of the first project and the second project.

4. The system of claim 1, wherein the information identifying the first project comprises at least one of type, location, time, and status information, and wherein the controller is further configured to provide the geocoded representation to at least one of a plurality of entities.

5. The system of claim 1, wherein the controller is configured to track changes to the project status attribute during a time period, and to include a tracked change in the geocoded representation.

6. The system of claim 1, wherein the project status attribute includes at least one of a project interference attribute, a project conflict attribute, a project milestone attribute, a project change attribute, a project progress attribute, a project schedule, and project conflict resolution attribute.

7. The system of claim 1, wherein the input module is configured to receive revised information identifying at least one of the first project and the second project, and wherein the controller is configured to modify the project status attribute based on the revised information.

8. The system of claim 1, wherein the input module is configured to receive revised information identifying at least one of the first project and the second project, and wherein the controller is configured to modify the geocoded representation based on the revised information.

9. The system of claim 1, wherein the geocoded representation includes a schedule to implement at least one of the first project and the second project.

10. The system of claim 1, wherein the geocoded representation includes information indicating a moratorium time period associated with a geographic location of at least one of the first project and the second project.

11. The system of claim 10, wherein the controller is configured to provide the geocoded representation with an indication that implementation of one of the first project and the second project is prohibited.

12. The system of claim 1, wherein the geocoded representation is configured to indicate authorization to implement of one of the first project and the second project.

13. The system of claim 1, wherein the controller is configured to juxtapose, in a display of the geocoded representation, a geographic location associated with the first project and a geographic location associated with the second project.

14. A computer implemented method of event coordination, comprising:
receiving information identifying a first project and information identifying a second project;
generating a geocoded representation of the information identifying the first project and the information identifying the second project;
identifying a project status attribute of at least one of the first project and the second project based at least in part on the information identifying the first project and the information identifying the second project; and
indicating the project status attribute in the geocoded representation.

15. The method of claim 14, wherein generating a geocoded representation of the information comprises representing the information identifying the first project and the information identifying the second project in a tabular format and in a geographic format.

16. The method of claim 14, comprising:
indicating, in the geocoded representation, time attributes associated with an implementation schedule of at least one of the first project and the second project.

17. The method of claim 14, further comprising providing the geocoded representation to at least two of a plurality of different entities.

18. The method of claim 14, further comprising tracking the project status attribute during at least one time period; and
including the project status attribute in the geocoded representation.

19. The method of claim 14, further comprising adjusting the geocoded representation based at least in part on a change in the project status attribute.

20. The method of claim 14, comprising:
receiving revised information identifying at least one of the first project and the second project; and
modifying the project status attribute based at least in part on the revised information.

21. The method of claim 14, comprising:
presenting a schedule for implementation of the first project and the second project.

22. The method of claim 14, comprising:
indicating that implementation of at least one of the first project and the second project is restricted.

23. The method of claim 22, wherein indicating that implementation of one of the first project and the second project is restricted comprises:
indicating a moratorium time period associated with a geographic location of at least one of the first project and the second project.

24. The method of claim 14, comprising:
authorizing implementation of one of the first project and the second project.

25. The method of claim 14, comprising:
juxtaposing, in the geocoded representation, a geographic location associated with the first project and a geographic location associated with the second project.

26. The method of claim 14, comprising:
notifying a plurality of entities of a change in the project status attribute based on at least one of a conflict, an opportunity, and a moratorium.

27. The method of claim 14, wherein receiving information the first project and information identifying the second project further comprises receiving information in a human readable format; and
wherein generating the geocoded representation further comprises generating the geocoded representation in a geocoded format.

28. A computer readable medium having stored thereon sequences of instructions, the sequences of instructions including instructions that, when executed by a processor, cause the processor to:
receive information associated with a first project at a first geographic location and information associated with a second project at a second geographic location;
juxtapose, in a geocoded representation of the information associated with the first project and the information associated with the second project, the first geographic location and the second geographic location;
identify a project status attribute of at least one of the first project and the second project based at least in part on at least one of the information associated with the first project, the information associated with the second project, the first geographic location, and the second geographic location; and
indicate the project status attribute in the geocoded representation.

29. The computer readable medium of claim 28, further comprising instructions that, when executed by the processor, cause the processor to:
receive information associated with the first project at the first geographic location and information associated with the second project at the second geographic location, wherein the first geographic location and the second geographic location are adjacent geographic locations.

30. The computer readable medium of claim 28, further comprising instructions that, when executed by the processor, cause the processor to:
receive information associated with the first project at the first geographic location and information associated with the second project at the second geographic location, wherein the first geographic location and the second geographic location at least partially overlap.

31. The computer readable medium of claim 28, further comprising instructions that, when executed by the processor, cause the processor to:
receive information associated with the first project at the first geographic location and information associated with the second project at the second geographic location, wherein the first geographic location and the second geographic location are separated by a third geographic location.
